(19) United States
(12) Patent Application Publication
(10) Pub. No.: US 2020/0165022 A1
(43) Pub. Date: May 28, 2020

(54) AN APPARATUS AND METHOD FOR AUTOMATED SORTING AND ENVELOPING OF HOMOGENEOUS AND/OR HETEROGENEOUS SUBSTANCES

(71) Applicant: Gauri SHANKAR ANGRISH, New Delhi (IN)

(72) Inventor: Gauri SHANKAR ANGRISH, New Delhi (IN)

(21) Appl. No.: 16/613,047

(22) PCT Filed: May 12, 2018
(86) PCT No.: PCT/IN2018/050301

§ 371 Date: Nov. 12, 2019

(30) Foreign Application Priority Data
May 12, 2017 (IN) 201711016721

(51) Int. Cl. B65B 57/10; B65B 5/06; B65B 61/02; B07C 5/34; B65B 35/10; B07C 5/02

(52) U.S. Cl. CPC B65B 57/10; B65B 5/06; B07C 5/02; B07C 5/3412; B65B 35/10; B65B 61/025

(57) ABSTRACT

The present invention relates to safer and more effective, comprehensive and economical apparatus and method that enables a fully-automated process for cutting, sorting and enveloping of combinations of individual units of homogeneous and/or heterogenous substances, including pharmaceutical products, which are retained in and/or without manufacturer's packaging, in exact customised quantities and combinations. There are also additional measures for ensuring appropriate quality controls at each step of the method. The invention ensures that the safety, efficacy and pharmacological properties of each medicine which are preserved at the time of consumption.

### FIELD OF THE INVENTION

This invention relates to a safer, effective, comprehensive and economical apparatus and method that enables a fully-automated process for cutting, sorting and enveloping of combinations of individual units of homogenous and/or heterogeneous substances, including pharmaceutical products, which are retained in and/or without manufacturer's packaging, in exact customised quantities and combinations. The invention also contains features such as tracking (traceability) of the source and the position of each individual unit in the output (i.e. the consolidated end product that is enveloped) and in-built quality check mechanisms. The invention ensures that the safety, efficacy and pharmacological properties of each medicine are preserved at the time of consumption.

### BACKGROUND OF THE INVENTION

There are various medicine management and dispensing apparatus known in the art, in automated and semi-automated varieties, which enable the dispensing of pre-sorted individual units of medication by dosage. However, the functionality and effectiveness of the medicine/pharmacy management systems in the existing art is limited due to their inability to (a) package pharmaceutical substances other than open pills (i.e. from which the manufacturer's packaging has been removed); (b) trace the source of each individual unit of drug/medicine once it is enveloped for the consumer; (c) determine the location of each individual unit of drug/medicine after it is enveloped for the consumers/patients; and (d) account for medicines other than solid pills, thereby excluding from the medicine/pharmacy management system all injections, syrups, powders and other non-oral solids and liquids and/or oral liquids that may be part of a consumer's prescribed treatment.

Unit-dose packaging machines known in the art can produce packages, boxes and pouches containing numerous types of tablets and capsules, and these are patient-friendly inasmuch as the packaged end products are available in several sizes and capacities and have features including informative labelling. However, such systems require that the manufacturer's container and packaging for the medicines should be removed before the medicines are grouped and re-packaged for consumption. In such a situation there is always a risk of contamination of medicines due to exposure to other medicines, moisture or humidity and resultantly leads to loss of their efficacy and pharmacological properties.

U.S. Pat. No. 7,123,989B2 relates to a method of dispensing a prescription drug to a customer which includes receiving a prescription for a particular customer from an authorized medical professional, choosing from an inventory of drugs a prescription drug to fill the prescription, creating a finished prescription by filling the prescription with the chosen prescription drug, and placing the finished prescription in a dispenser.

US20070173971A1 relates to a method for providing medication compliance packaging which includes entering a pharmaceutical order into a database at a local pharmacy, reading the pharmaceutical order from the database, and communicating the pharmaceutical order to a compliance packaging device at a compliance packaging hub.

U.S. Pat. No. 6,021,392A relates to a computerized electronic interface between the hospital software system that tracks the drug distribution within the hospital and the drug distributor's software system at the drug distribution centre. U.S. Pat. No. '392 also provides complete drug and supply tracking from the drug supplier to a nursing station automated drug/supply dispensing machine.

US20080306740A1 relates to a method which includes:
(1) receiving information associated with two or more tasks to be performed in relation to one or more semi-automatic devices;
(2) dynamically prioritizing the two or more tasks based at least in part on a set of rules defining the relative priorities associated with the two or more tasks; and
(3) communicating an instruction associated with one of the two or more tasks based at least in part on the dynamic prioritization.

Further, U.S. Pat. No. '740 also relates to a semi-automated system for enabling a user to remotely and interactively control, using voice commands, the processing tasks of multiple pieces of equipment, such as semi-automatic medication storing, dispensing and packaging devices

US20070068959A1 discloses a system for preparing individualized dosage forms in which a processor is configured to identify a medicament formulation for an individual patient's dosaging needs and communicates this formulation information to a dispensing station where a capsule or a formulation of pellets of small diameter size for reconstitution into a liquid or semi-solid is formed that is specific to the individual's dosaging needs. Additionally, U.S. Pat. No. '959 also discusses methods for preparing individualized dosage forms of medicines, vitamins, mineral supplements and nutraceuticals in capsule or liquid form.

U.S. Pat. No. 7,129,819 relates to a system and method for a modular drug releasing system which dispenses and releases to a consumer medication in the form of pills, tablets, and capsules in accordance with data received from a central computarised device. Further, U.S. Pat. No. '819 also discusses about sorting of open pills as one of a preliminary step of method of drug release system.

A number of limitations present in the prior art are as follows:
1. The existing machines and systems enable the re-packaging of only open pills i.e. oral solids (i.e. tablets and capsules) that are not contained in manufacturers' packaging. It is relevant that the removal of manufacturer's packaging and the storage of such open medicines over several days can result in the loss of their efficacy and pharmacological properties. Further, medicines are susceptible to alteration as a result of their exposure to heat, light and interaction with other medicines, and such reactions adversely affect the safety of the medicines. Further, the retail sale of open pharmaceutical products and such re-packaged medication is not permitted under applicable law in India and various other countries.
2. The existing machines and systems are not capable of tracking the source of each medicine automatically; accordingly, after the medicines are repackaged in the pouch for the patient's consumption, tracing each medicine after it is enveloped or pouched and determining its location is impossible.
3. The existing machines and systems do not take into account non oral pills and drugs and/or oral liquids/powder/injections, the pharmacy/medicine management system rendered thereby is neither comprehensive nor complete.
4. The existing machines and systems are very immensely priced.

Accordingly, there is a need to obviate the lacunae in the prior art and provide a simple and more comprehensive solution that enables a convenient, safer, cost-effective and portable system of multiple-dose medicine management that is both safe and easy for consumer/patient use. The present invention includes relevant safeguards at every step to ensure that the medicines/drugs prescribed to a specific consumer/patient are consolidated and available for consumption in an error-free manner in an exact and customised (a) combination; (b) quantity; (c) dosage; (d) period of time; and (e) chronological order of consumption. The present invention is to retain the safety, efficacy and pharmacological properties of each medicine by preserving retaining the manufacturer's original packaging at the time of consumption. The present invention also provides an economical apparatus and method for automated sorting and enveloping of homogeneous and/or heterogeneous substances.

The present invention also provides a comprehensive system for management of all types of substances such as drugs/medicines by using FLAT TABS, cardboard or any other material representatives of those substances that cannot be pouched or enveloped. Further, it allows for easy adoption by consumer/patients by labelling of each dose pouch in various languages.

The present invention also ensures prevention of any future harm which may occur due to inclusion of any defective/contaminated medicine. In particular, the present invention enables traceability of original batch details of each medicine and therefore it can be easily ascertained that from which batch a particular defective medicine is being emanated so that appropriate remedial measures can be taken in this regard. Additionally, it eliminates the possibility of an expired substance being enveloped and dispensed to the consumer/patient.

### Object of Present Invention

An objective of the present invention is to provide an economical, fully automated multi-dose dispensing and enveloping apparatus and mechanism, including cutting, sorting and enveloping, for all types of homogenous and/or heterogeneous substances, including pharmaceutical products and oral solids such pills, which are either retained in manufacturer's packaging or otherwise, in the exact quantities and combinations as required by the end user. Enveloping of substances retained in manufacturers packaging ensures safety, efficacy and, in case of medicines, pharmacological properties of enveloped substances.

Another objective of the present invention is to provide safeguards and in-built quality control mechanisms at every step of automated sorting and enveloping of homogeneous and/or heterogeneous substances including pharmaceutical products and oral solids such pills to ensure that the substances and/or drugs/medicines enveloped for each user/consumer are consolidated and available for consumption each time in an exact and customised (a) combination; (b) quantity; (c) dosage; (d) period of time; and (e) chronological order of consumption as prescribed by the doctor.

Another objective of the present invention is to maintain complete traceability of the homogeneous and/or heterogeneous substances including pharmaceutical products and oral solids such pills being enveloped by capturing and tracking the manufacturer's information of the enveloped substances.

The present invention provides a comprehensive mechanism with inclusion, to the highest extent, of all types of substances—for example, in the case of pharmaceutical products, these would include, but not be limited to, both non-oral solids and liquids along with oral liquids in addition to the aforementioned oral solids. This is done with the help of FLAT TABS i.e. cardboard or other material representatives of each type of medicine that cannot be enveloped in the present mechanism. Inclusion of relevant FLAT TABS in pouches, when required by the prescription, along with labelling the pouch with name and dosage direction of the oral liquid or non-oral solid or liquid, provides a definite reminder to the consumer/patient for each dose when the said medicine has to be taken. Such FLAT TABS can be used as an indicator for replacement in the case of all kinds of homogenous and heterogeneous substances.

The present invention also makes the end product relevant and legible for all types of users/consumer. Each pouch bears a printed label containing clear instructions for dosage, timing and consumption as prescribed for each substance in that pouch, and also specifies the expiry dates of such substances. Further, it also allows labelling of pouches/final product in several languages and vernaculars along with labelling in braille, for easy adoption by visually impaired users. This is done by internal mechanisms that translate and/or transliterate each word to be labelled into relevant languages and/or Braille and inbuilt printers that print accordingly.

The present invention provides a comprehensive solution for automated sorting and enveloping of homogeneous and/or heterogeneous substances including pharmaceutical products and oral solids such pills, with additional feature. At the same time making it more economical than aforementioned existing prior art and therefore reduce the capital and operating costs associated with pharmacy and/or medicine management at any dispensing site.

The present invention includes relevant safeguards at every step to ensure that the medicines prescribed to a specific consumer are consolidated and available for consumption each time in an exact and customised (a) combination; (b) quantity; (c) dosage; (d) period of time; and (e) chronological order of consumption

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

Other advantages and details about the apparatus and method will become more apparent to a person skilled in the art from the below detailed description of the invention when taken in conjugation with the drawings.

### BRIEF DESCRIPTION OF THE ACCOMPANYING DRAWINGS

The following drawings are illustrative of particular embodiments for enabling system and method of the present invention and are not intended to limit the scope of the invention. The drawings are not to scale (unless so stated) and are intended for use in conjunction with the explanations in the following detailed description.

FIG. 1 is an exemplary representation of apparatus for automated cutting, tracking and Cartridge filling of homogeneous and/or heterogeneous substances where the invention may be implemented.

FIG. 2A-2E is an exemplary representation of parts of the Cartridge of the present invention.

FIG. 2F is an exploded view of all components of the Cartridge of the present invention.

FIG. 3 is an exemplary representation of additional details of assembly of the apparatus for automated sorting and enveloping of homogeneous and/or heterogeneous substance

FIGS. 4A and 4B is an exemplary representation with another additional details of assembly of the apparatus for automated sorting and enveloping of homogeneous and/or heterogeneous substance

FIG. 5 is an another part of assembly of the apparatus for automated sorting and enveloping along with dispensing and filling of Carefills of homogeneous and/or heterogeneous substance

FIG. 6 is a flowchart to illustrate method for automated sorting and enveloping of homogeneous and/or heterogeneous substances.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF THE EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of skilled in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

Few terms used and referred in the present inventions are as follows:

“Flat-tab” refers to a small piece of cardboard or other material that represents one unit of non-pouchable medicine prescribed for consumption at one time. A flat-tab is enveloped into a pouch and serves as a reminder to the consumer for taking the corresponding non-pouchable medicine (available separately) according to the prescribed dosage;

“Cartridge” refers to standardized containers with multiple slots. Each slot holds one unit of a substance, medicine and/or flat tab and each cartridge holds only one type or brand name of the substance, medicine and/or flat tab

“Individual Unit” refers to one singular unit of a particular type of medicine without removing the manufacturer's packaging;

“Manufacturing Information” refers to information (including the batch number and expiry date) printed by the manufacturer on each strip of medicine;

“Order ID” refers to the distinct identification number of a specific order in relation to a particular patient and contains information in respect of medicines, prescriptions and dosage instructions obtained directly from customers and approved by pharmacists. The order ID is derived from aggregate information recorded in a proprietary database categorised by identification numbers;

“Non-pouchable Medicines” refers to (1) all medicines that are not packaged by the manufacturer in strips, and are marketed in other forms such as bottles and vials; (2) pills required to be consumed in half or partial quantities; and (3) any medicine for which the manufacturer's packaging is required to be disrupted in to enable its consumption in exact quantities due to its form, dosage or prescription;

“Order” refers to the sequence of dose pouches for tenure of time interval, as specified by the customer/patient. It may be 15 days or 30 days or any specified number of as provided by customer/patient;

“Pouch” refers to the container which is made up of materials including but not limited to plastic that envelopes the pouch load and bears a printed label containing details in respect of each medicine in the pouch load, including the (1) day, date and time of dosage; (2) food directions for dose consumption; (3) names of the medicines; (4) quantities of medicines; (4) expiry dates of medicines; and (5) bar code or identification number of the pouch;

“Pouch Load” refers to the exact combination of the various individual units and/or flat-tabs, where necessary;

“Pouchable medicines” refers to oral solid medicines (including pills) packaged by the manufacturer in strips; or any medicine for which the manufacturer's packaging is not required to be disrupted to enable its consumption in exact quantities due to its form, dosage or prescription;

“Carefill” refers to a paper-back housing that houses the pouches for each refill of the patient.

### DESCRIPTION

The present invention relates to an apparatus for automated sorting and enveloping of homogeneous and/or heterogeneous substances which comprises of:
a tracking unit for tracking homogeneous and/or heterogeneous substances including medicine/drug strips and information on such substance;
a cutting unit to cut homogeneous and/or heterogeneous substances including medicine/drug strips;
a Cartridge with slots for loading of individual units of homogeneous and/or heterogeneous substances including medicine/drug;
a loading bay to load the Cartridges which contain the individual units of homogeneous and/or heterogeneous substances including medicine/drug;
a motor hub for calibrating Cartridge slots for sorting of the individual units of homogeneous and/or heterogeneous substances including medicine/drug;
a conveyor belt to carry the individual units of homogeneous and/or heterogeneous substances including medicine/drug into a pouch forming chute;
a printing unit for labeling of film which is used for forming a pouch;
a horizontal and vertical heat-sealers to seal the pouches for securing the enveloped individual units resulting in four side sealed pouches;
a dispensing unit for dispensing of the sealed and labeled pouches;
a filling unit for filling dispensed pouches into Carefills; and
sensors that track radio frequency based tags, optical machine formats/codes, and/or individual unit movement using micro-stepper motors.

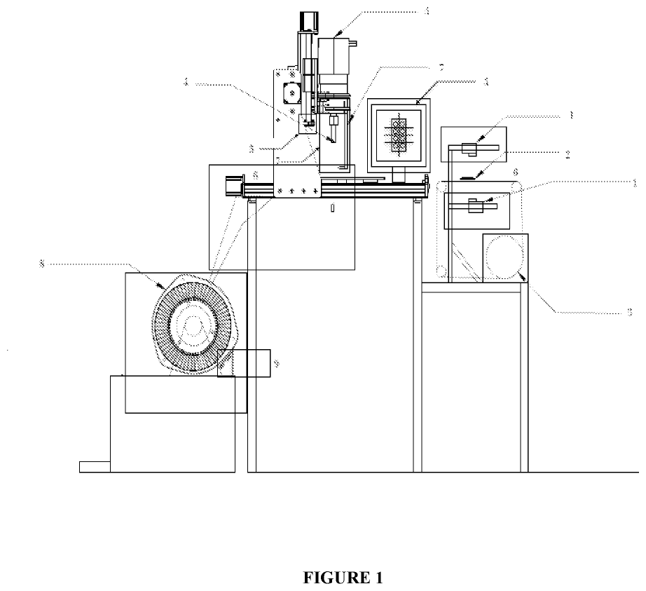

A schematic representation of a system where the present invention may be implemented is illustrated in FIG. 1. FIG. 1 illustrate an apparatus (20) for automated sorting and enveloping of homogeneous and/or heterogeneous substances which comprises of Cameras (1 and 1′) which are a part of a tracking unit and is present on the top and bottom of a conveyor belt made of transparent material.
optical machine format reader (2) which is a part of tracking unit and is present at the top and/or bottom of the conveyor belt;
a conveyor motor (3);
cutting unit which includes laser cutters comprising of laser head (4) and laser tip (4′) and Human Machine Interfaces (HMI) (4″) to help assist with laser cutting;
third camera (5) placed after the laser cutting;
two conveyor belts (6); one in between the two cameras and the second one after the laser cutter;
air jet (7) and/or pneumatic pumps and/or mechanical pushers at the edge of the second conveyor belt;
loading bay (10) that holds a Cartridge (8);
radio frequency based programmer (9) to program the radio frequency based tag present on the Cartridge (8).

The top and bottom cameras (1 and 1′) carry out imaging and tracking of substances (including pharmaceutical products) retained in the manufacturer's packaging. The imaging is of shape and size recognition of the medicine/drug strip. The optical machine format reader (2) at the top and/or bottom carry out optical character recognition of manufacturer's information printed on the packaging. The first conveyor belt (6) transports the strips to the laser cutting area. The HMI (4″) projects relevant grid lines from internal database post recognition from imaging mentioned above. This HMI (4″) also allows for adjustment of grid lines by the operator, in case the relevant ones do not exist in the internal database.

Further, the laser cutters (4) cut the medicine/drug strips into individual units according to projected grid lines. Then, the third camera (5) photographs each cut unit pill from the top. The second conveyor belt (6) and air jet and/or other mechanisms including but not limited to pneumatic pumps and mechanical pushers transport and direct the each cut individual unit into single slots of the Cartridge (8) via a funnel in the same order as they are cut and photographed, to maintain traceability.

The loading bay holds the Cartridge (8) and rotates it in synchronization with the cutting mechanism. It also houses the Radio frequency based programmer (9) to program the Radio frequency based tag present on the Cartridge (8) with relevant information of the unit pills filled into that Cartridge (8).

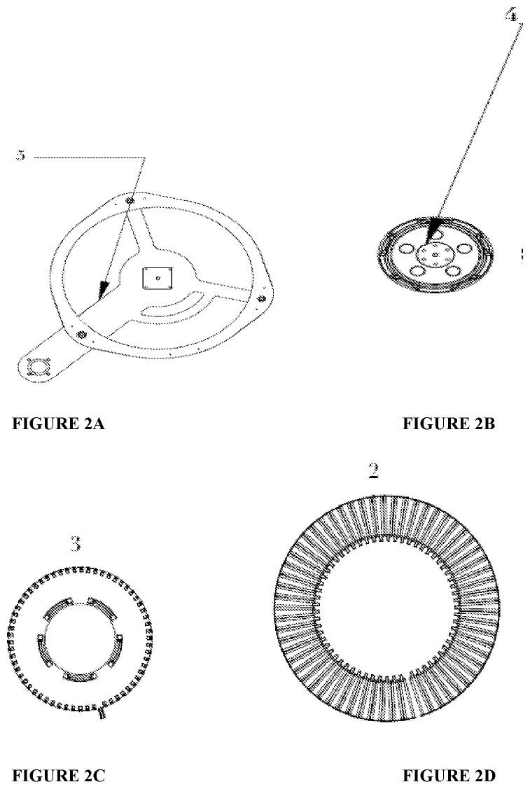

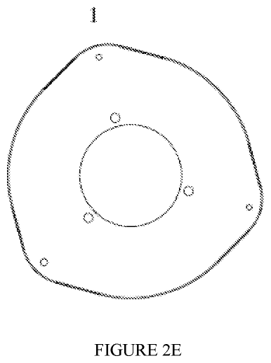

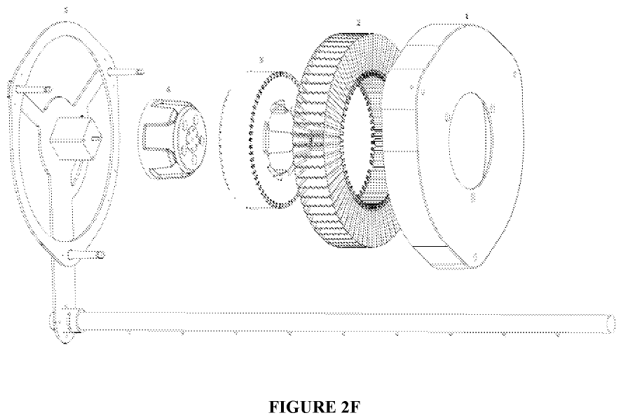

FIG. 2A shows arrangement of the assembly Motor arm (25) present on the side of the apparatus (20) including outer cover, multiple individual slots, cartridge hub and motor hub and is a part of the Cartridge (8) outer covering of the Cartridge which houses the Radio frequency based tag/chip which has a unique ID.

FIG. 2B shows a motor hub (24) present as an inner later to a cartridge hub (23). Then FIG. 2C shows cups (22) with multiple individual slots that are covered by the outer covering mentioned above. Further, FIG. 2D illustrates the cartridge hub (23) present as an inner layer to the multiple individual slots. FIG. 2E shows outer covering (21) of the Cartridge (8) which houses the Radio frequency based tag/chip which has a unique identification (ID).

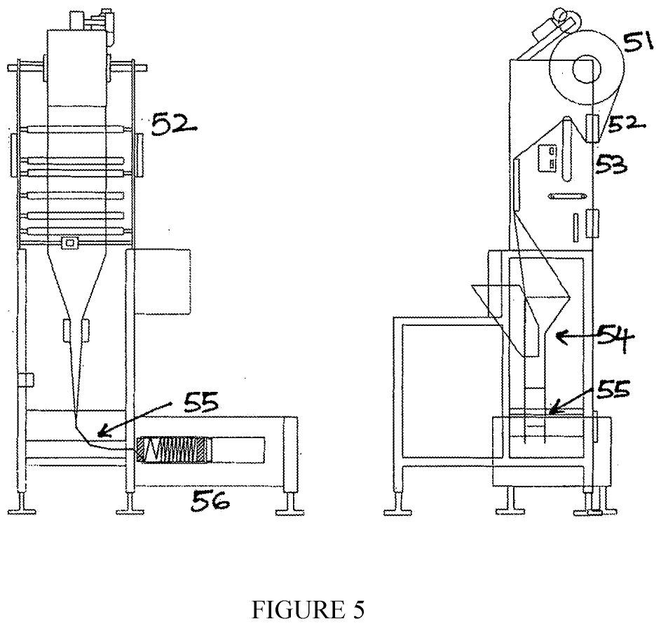

The outer cover of the Cartridge (8) that has an opening to allow for filling of unit pills into individual slots of each Cartridge, as described in FIG. 1. This opening also allows dispensing of relevant unit pills from the slots as described later in FIG. 5. This outer cover also provides the function of protecting the inner components of the Cartridge (8) and retaining the individual units of medicines/drugs in the individual slots. Another function of the outer cover is to house the Radio Frequency based tag or chip which has a unique ID and is reprogrammable with information of the type and quantity of unit pills that are loaded in the Cartridge, as explained in FIG. 1 above.

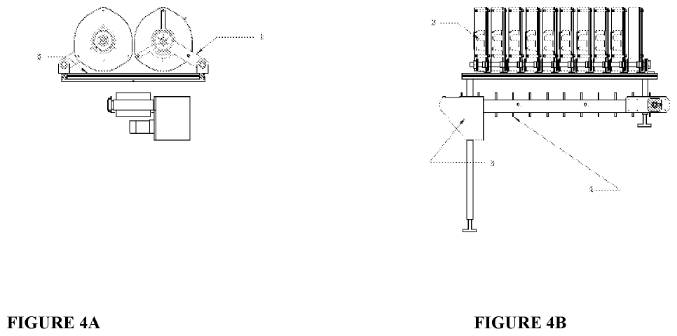

The individual slots house individual units of medicines/drugs. The cartridge hub and a motor hub aid the rotation of the Cartridge (8) when loaded on to the motor arm. Further, the motor arm is a part of the loading bay as described in FIG. 4, below.

Further, FIG. 2F is an exploded view of all the aforementioned components of the Cartridge as described in FIG. 2A to 2E and how they fit into each other.

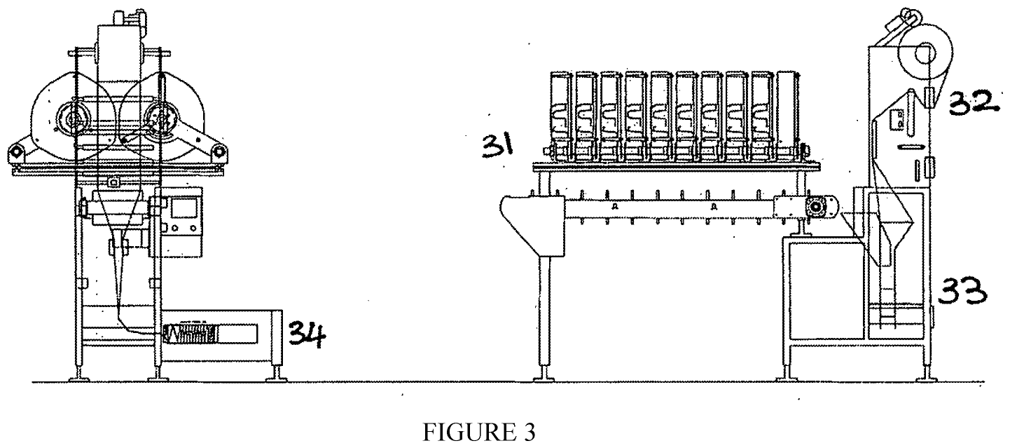

FIG. 3 illustrate an assembly of apparatus (20) which includes:
a loading and the dispensing bay (31) that comprises the loaded Cartridges and conveyor belts along with the sensors;
a printing unit (32) that is present on top of the pouching area;
the pouching area (33) that is present below the printing unit (22) and on the side of the loading and dispensing bay (31);
a pouch dispensing and Carefill (34) filling area that is present below the pouching area (33).

The loading houses all the cartridges and Radio frequency based sensors to confirm the correct and right quantities of the Cartridges have been loaded. The dispensing bay (31) dispenses the relevant individual units onto the conveyor belt and confirms the same with installed sensors. Further, the conveyor belt carries and drops the dispensed individual units into the pouching area and confirms the same with installed sensors at the end of the conveyor belt.

Thus, the installed sensors:
confirm loading individual units into Cartridge slots;
confirm loading of correct Cartridges and quantities on loading bay
confirm dispensing individual units from Cartridge slots onto the conveyor belt; and
confirm dispensing Pouch load of individual units into labeled pouch;

Then the printing unit (32) carries out labelling of the tensed enveloping film using a printer. The pouching area carries out pouching of the individual units. Once the exact number of pills are dropped by the conveyor belt fall into the printed part of the enveloping film as detailed in FIG. 5 via the pouch forming chute, post folding and sealing of the enveloping film from three sides by horizontal and vertical heat sealers, the enveloping film is sealed from the fourth end, hence completely sealing the pouch. Additionally, a notch is added which aids the end consumer to open the pouches and get access to the contents, when needed. It is to be noted that only a set number and/or total volume of pills can fit into each pouch. This is pre-calculated by the internal mechanism and that information is provided to this assembly so that only those number and type of pills fall into the relevant pouch. If the limit is exceeded then the assembly automatically fills multiple pouches for that particular dose.

The Carefill filling area dispenses all the pre-organised, enveloped and labelled multi-dose pouches of each patient's refill in accordance with their chosen dispensing or delivery cycle. Furthermore, these multi-dose pouches, dispensed in chronological order are automatically filled into a refill also called Carefill. Additionally, the last pouch to enter the said refill, which will eventually be the first pouch that is pulled out by the end user, is a blank pouch that is labelled with the name of the patient, the start date (representing the day the medicines need to start being consumed) and the tenure of the enveloped medicines. Lastly, the assembly also prints and dispenses a label, which is to be manually attached to the back of the refill, which has the same information as on the first blank pouch of each refill.

FIG. 4A shows additional details of assembly of the apparatus (20). The additional components includes Rotator arms (41) that are present on the loading bay that has been detailed in FIG. 3 and frame (45) that is the mechanical structure on which the loading bay rests.

FIG. 4B shows also additional details of assembly of the apparatus (20). The additional components includes:
stepper motor (42) that is present in on the rotator arms;
Conveyor motor (43) present beneath the conveyor belt that has been detailed in FIG. 3; and
Conveyor cleats (44) are separations present on the conveyor belt that has been detailed in FIG. 3.

The rotator arms (41) are linked to each Cartridge, that is, each Cartridge is loaded on to one rotator arm. Further, the stepper motor (42) helps the rotator arm (41) to move in synchronization with the complete dispensing mechanism and also helps calibrate the slots of the Cartridges (8) when the Cartridge (8) is rotated by the rotator arm (41). The stepper motor (42) is activated once the stepper motor of the relevant Cartridge is alerted by the internal mechanism to dispense an individual unit.

The conveyor motor (43) allows the conveyor belt to move in synchronization with the dispensing mechanism to be able to transport the dispensed individual units from each cartridge to the pouching chute as has been detailed in FIG. 3.

The conveyor cleats (44) contain the dispensed unit pills on specific sections of the conveyor belt allowing for easier transportation to the pouching chute and traceability. The frame allows for stability of the mechanisms in the loading and dispensing bay

FIG. 5 shows the assembly of apparatus 20 with another additional details which includes:
film roller (51) that holds the roll of enveloping film made of plastic or other material;
calendaring apparatus (52) present below the roller that creates tension in the enveloping film for ease of printing/labelling;
printing unit (53) that houses the Label printer which prints;
pouch forming chute (54) that is present below the printing unit and next to the loading and dispensing bay that have been described in detail in FIG. 3;
pouch sealing area (55) present below the pouch forming chute; and
pouch dispensing unit and Carefill filling unit (56) that is present on the side of the pouch sealing area.

In the apparatus (20) for automated sorting and enveloping of homogeneous and/or heterogeneous substances, the film roller (51) holds the roll of enveloping film made of plastic or other material. Further, the calendaring apparatus (52) that stretches the enveloping film to create enough tension so it becomes possible to print directly onto the enveloping film.

The printer present in the printing unit (53) prints directly onto the enveloping film in multiple languages, as directed by the internal mechanism. The printing is carried out in synchronization with the pouching assembly as detailed in FIG. 3 so that the individual contents of the dose enveloped into one pouch match the printing of the dose details and dosage directions on that pouch. In addition to multiple languages, the printer also has the capacity to print graphics, numbers and Braille. It is to be noted that only a set number and/or total volume of pills can fit into each pouch. This is pre-calculated by the internal mechanism and that information is provided to this assembly so that only the names & dosage directions of those number and type of pills is printed onto the relevant section of the film (plastic or other material). If the limit is exceeded then the assembly automatically prints multiple pouches for that particular dose.

The fully-automated method for tracking, cutting, sorting, enveloping, labelling and dispensing of individual units of assorted substances, in multi dose pouches, without removing the manufacturer's packaging includes the following steps:
(A) tracking of medicine strips, including capture of images and information like manufacturer's information including name, batch number, expiry date, etc. to be used in the subsequent stages;
(B) cutting of medicine strips into individual units and retaining the manufacturers' packaging, while simultaneously scanning and obtaining relevant images and dimensions of the individual units to be used in subsequent stages;
(C) loading of the individual units into cartridges. Each individual unit is filled in one single slot of the cartridge and each cartridge is tagged with a unique identification (ID) by programming in-built Radio frequency based tag or optical machine readable formats on each cartridge. It is from these cartridges that the individual units are obtained to form correct combinations for consumption in a pouch load according to a prescribed dosage in a subsequent stage;
(D) loading of the cartridges into the loading bay. The loading bay is loaded with the exact number of cartridges required for that specific order along with the exact type of cartridge, checked by scanning the radio frequency based tags or optical machine readable formats on each cartridge;
(E) sorting of individual units, dispensed from relevant cartridges to make pouch loads, exactly according to prescribed dosages;
(F) enveloping and labelling of the pouch load into a labelled pouch meant for dispensing exact quantities and combinations of medicines in a prescribed dosage over a specified period of time in chronological order of consumption;
(G) dispensing the pouches of the order with exact quantities and combinations of medication, without removing the manufacturer's packaging, to the consumer/patient for consumption in chronological order over a specified period of time; and
(H) filling the pouches of one order into Carefills which are then labelled with information about patients/consumers and complete Order;

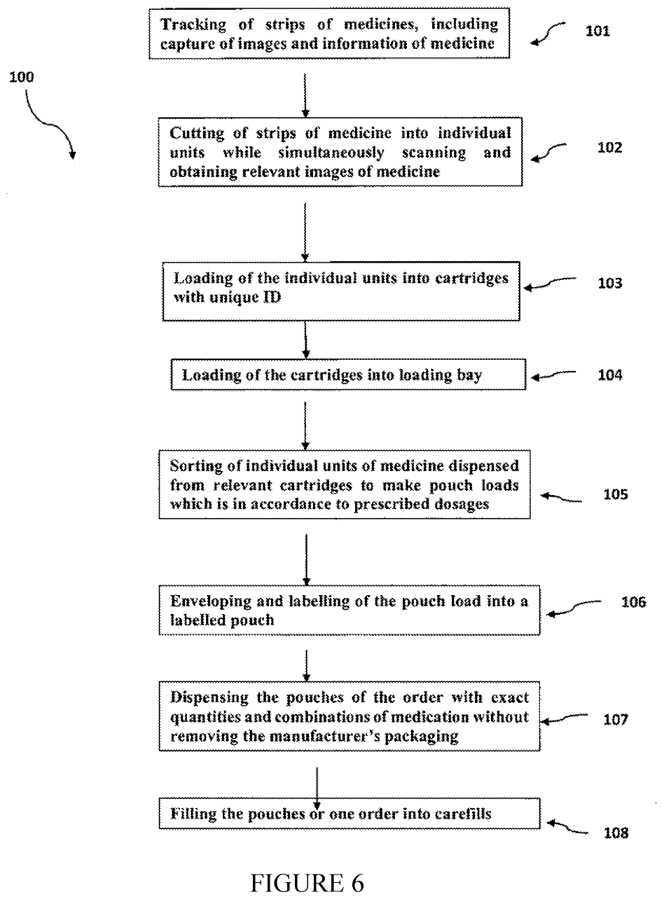

FIG. 6 is a flowchart illustrating the fully-automated method for tracking, cutting, sorting, enveloping, labelling and dispensing of individual units of homogeneous and/or heterogeneous substances without removing the manufacturer's packaging, using the apparatus (20).

At step 101, tracking of medicine/drug strips is performed using cameras (1 and 1′). The tracking of medicine includes capture of images of medicine/drug strips and collection of information like manufacturer's information including name, batch number, expiry date, etc. along with shape, size and machine readable optical code, if any, of medicine/drug strips.

At step 102, cutting of medicine strips into individual units is performed using lasers and Human Machine Interface (HMI) (4′). During cutting of strips of medicine into individual units, in the manufacturers' packaging is retained. Simultaneously scanning and obtaining relevant images and dimensions of the individual units is performed. Thereafter, installed sensors confirms the dispensing of such individual unit into slots of the Cartridges (8).

At step 103, individual units are loaded into cartridges, while tracking slot location of such individual units. Each individual unit is filled in one single slot of the Cartridge and each cartridge is tagged with a unique ID by programming the in-built Radio frequency based tag or optical machine readable formats on each cartridge. Further, from these Cartridges (8), the individual units are automatically dispensed to form correct combinations of medicines/drugs for consumption to the patients/end users in a pouch load according to a prescribed dosage.

At step 104, the cartridges are then loaded into the loading bay. The loading bay is loaded with the exact number of Cartridges required for that specific order along with the exact type of cartridge. It is checked by scanning the radio frequency based tags or optical machine readable formats on each Cartridge ( ).

At step 105, sorting of individual units is achieved by dispensing from relevant Cartridges (8) to make pouch loads that are exactly according to prescribed dosages. The dispensing of individual units is performed with the help of gravity and use of calibrated cartridge slots. Thereafter, sensors installed at the loading bay (10) confirms the dispensing of such individual unit on to the conveyor belt.

At step 106, enveloping and labelling of the pouch load into a labelled pouch meant for dispensing exact quantities and combinations of medicines in a prescribed dosage over a specified period of time in chronological order of consumption, is accomplished by dropping of these combination of medicines from the conveyor belt into the pouch forming chute(54). Installed sensors ( ) confirms the dropping of these combination of medicines into the pouch forming chute (54). Further, the pouch forming chute(54) envelops such combination of medicines with pre-labelled film which is labelled using the printing unit (52). Printing of the labels of pouch is done in several languages, including Braille.

At step 107, dispensing of labelled pouches is executed using motors and without removing the manufacturer's packaging of drugs/medicines. The labelled pouches contain the information for the patient for consumption in chronological order over a specified period of time. Further, the pouches are in the order of consumption by the patients with exact quantities and combinations of medication.

At step 108, filling of the labelled pouches of one order into Carefills is performed which are then labelled with information about patient/consumer and complete Order.

Accordingly, the method for automated sorting and enveloping of homogeneous and/or heterogeneous substances which maintains complete traceability of the homogeneous and/or heterogeneous substances is performed. Further, by retaining the manufacturer's packaging of drugs/medicines ensures the safety and efficacy of method for automated sorting and enveloping of homogeneous and/or heterogeneous substances. As a result of above, a user will get a convenient, safer, cost-effective and portable system of multiple-dose medicine management that is both safe and easy for consumer/patient use.

It should be understood that any of the embodiments of the present system can be implemented by using the economical apparatus for automated sorting, enveloping and tracking of homogeneous and/or heterogeneous substances including pharmaceutical products, which are retained in and/or without manufacturer's packaging, in exact customised quantities and combinations.

Based on the disclosure and teaching provided herein, a person of ordinary skill in the art will know and appreciate other ways and/or methods to implement embodiments of the present invention. Further, any of the methods describes herein may be totally or partially performed using the abovementioned apparatus, which is configured to perform the steps described herein above.

It would be obvious to those skilled in the art that, based on the concepts, ideas and issues described herein, several variations of the proposed method being considered as well as for apparatus for automated sorting and enveloping of homogeneous and/or heterogeneous substances with distinctly different steps and process, are possible without deviating from the scope of this invention.

In conclusion, the present invention provides an improved solution to automated sorting, enveloping and tracking of homogeneous and/or heterogeneous substances including pharmaceutical products. While detailed descriptions of one or more embodiments of the invention have been given above, various alternatives, modifications can be ascertained by a person skilled in the art based on the description given hereinabove. Thus, the above description should not be taken as limiting the scope of the invention.

I claim:

1. An apparatus for automated sorting and enveloping of homogeneous and/or heterogeneous substances which comprises of:
a tracking unit for tracking homogeneous and/or heterogeneous substances including medicine/drug strips and information on such substance;
a cutting unit to cut homogeneous and/or heterogeneous substances including medicine/drug strips;
a Cartridge with slots for loading of individual units of homogeneous and/or heterogeneous substances including medicine/drug;
a loading bay to load the Cartridges which contain the individual units of homogeneous and/or heterogeneous substances including medicine/drug;
a motor hub for calibrating Cartridge slots for sorting of the individual units of homogeneous and/or heterogeneous substances including medicine/drug;
a conveyor belt to carry the individual units of homogeneous and/or heterogeneous substances including medicine/drug into a pouch forming chute;
a printing unit for labeling of film which is used for forming a pouch;
a horizontal and vertical heat-sealers to seal the pouches for securing the enveloped individual units resulting in four side sealed pouches;
a dispensing unit for dispensing of the sealed and labeled pouches;
a filling unit for filling dispensed pouches into Carefills; and
sensors that track radio frequency based tags, optical machine formats/codes, and/or individual unit movement using micro-stepper motors

2. An apparatus for automated sorting and enveloping as claimed in claim 1, wherein the tracking unit includes cameras and optical machine format readers.

3. An apparatus for automated sorting and enveloping as claimed in claim 1, wherein the cutting unit includes laser and HMI.

4. An apparatus for automated sorting and enveloping as claimed in claim 1, wherein the Cartridge contains multiple slots, a motor hub, motor arm and an outer cover with radio frequency based tag.

5. An apparatus for automated sorting and enveloping as claimed in claim 1, wherein installed sensors
confirm loading individual units into Cartridge slots;
confirm loading of correct Cartridges and quantities on loading bay
confirm dispensing individual units from Cartridge slots onto the conveyor belt;
confirm dispensing Pouch load of individual units into labeled pouch;

6. A method for automated sorting and enveloping of homogeneous and/or heterogeneous substances which comprises of:
tracking of medicine strips;
cutting of medicine strips into individual units and retaining the manufacturers' packaging and simultaneously scanning and obtaining images of the individual units;
loading of the individual units into single slots of cartridges, tagged with an unique identification, while tracking the exact slot location of such individual units;
confirming the loading of the individual units into single slots of cartridges by way of a sensor;
loading of the cartridges into a loading bay which is loaded with the exact number of cartridges required for that specific order along with the exact type of cartridge;
confirming loading of the correct cartridges and exact number of cartridges, required for that specific order, by way of a radio frequency or optical machine format readers;
sorting of individual units, dispensed from the relevant cartridges to make pouch loads exactly in accordance to prescribed dosages;
confirming dispensing of the individual units from each cartridge by way of a sensor;
enveloping and labelling of the pouch load into a labelled pouch meant for dispensing exact quantities and combinations of medicines in a prescribed dosage over a specified period of time in chronological order of consumption;
confirming the loading pouch load into the labelled pouch by way of a sensor;
dispensing the pouches with exact quantities and combinations of medication, without removing the manufacturer's packaging, to the patient for consumption in chronological order over a specified period of time; and
filling the pouches of one order into Carefills, which are then labelled with information about patient/consumer and complete Order.

7. The fully automated method as claimed in claim 6, wherein tracking of strips of medicines is performed by capture of images of the medicine strip and collection of manufacturer's information including name, batch number, expiry date as present on the medicine strip along with shape, size and optical machine readable code/format on the medicine strip.

8. The fully automated method as claimed in claim 6, wherein tagging of cartridge with unique identification is performed by programming in-built Radio frequency based tag or optical machine readable formats on each cartridge.

9. The fully automated method as claimed in claim 6, wherein the pouch that contains exact quantities and combinations of medicines in a prescribed dosage can be labelled in several languages including Braille.

10. The fully automated method as claimed in claim 6, wherein installed sensors
confirm loading individual units into Cartridge slots;
confirm loading of correct Cartridges and quantities on loading bay
confirm dispensing individual units from Cartridge slots onto the conveyor belt;
confirm dispensing Pouch load of individual units into labeled pouch;
